(19) United States
(12) Patent Application Publication
(10) Pub. No.: US 2008/0174247 A1
(43) Pub. Date: Jul. 24, 2008

(54) High Power Lamp and LED Device Thereof

(75) Inventors: Jyh Ming Yu, Kaohsiung City (TW); David Shau Chew Wang, Taipei City (TW); Jen Chien Wang, Sinjhuang City (TW); Hsieh Chang Huang, Toufen Town (TW)

Correspondence Address: Connolly Bove Lodge & Hutz LLP, Suite 800, 1990 M Street, N.W., Washington, DC, 20036, US

(73) Assignee: POLYTRONICS TECHNOLOGY CORPORATION, Hsinchu (TW)

(21) Appl. No.: 11/755,196

(22) Filed: May 30, 2007

(30) Foreign Application Priority Data
Jan. 24, 2007 (TW) 096201379

(51) Int. Cl. H05B 37/02; H01J 7/44

(52) U.S. Cl. 315/32; 315/291

(57) ABSTRACT

A high-power LED lamp comprises a cuplike lamp housing, an LED device, an adapter and a circuit board. The inner surface of the cuplike lamp housing is a reflective curved surface for reflecting the light from the LED device disposed at the bottom the cuplike lamp housing, so as to improve the lighting efficiency. The position of the LED device has the relation: 0.05<H_{L}/H_{T}<0.35, where H_{T} is the total depth of the cuplike lamp housing, H_{L} is the distance between a surface of the LED device and the bottom of the cuplike lamp housing. The adapter is configured to secure the LED device, and the circuit board is configured to provide power source to the LED device. The LED device is a stack structure comprising an LED package device, a ring member, an electrode plate and an insulation glue layer. The LED package device comprises at least one LED die, the ring member is disposed below the LED package device, the electrode plate is disposed below the ring member and is provided with a rod at the center thereof. The rod penetrates through the ring member and is connected to a bottom of the LED package device. The insulation glue layer is disposed between the electrode plate and the ring member for insulation between positive and negative electrodes.

### BACKGROUND OF THE INVENTION

(A) Field of the Invention

The present invention relates to a high-power light emitting diode (LED) lamp and the LED device thereof.

(B) Description of the Related Art

In recent years, white LEDs have become a very popular new product attracting widespread attention all over the world. Because white LEDs offer the advantages of small size, low power consumption, long life, and quick response speed, the problems caused by using conventional incandescent bulbs can be solved. Therefore, the applications of LEDs in backlight sources of displays, mini-projectors, illumination, and car lamp sources are becoming increasingly important in the market.

At present, Europe, the United States, Japan, and other countries have a consensus with respect to energy conservation and environmental protection, and in the new century are actively developing the white LED as a new light source for illumination. Currently, energy is imported in many countries, so it is worthwhile to develop the white LED in the illumination market. Based on the evaluation of experts, if all the incandescent lamps in Japan are replaced with white LEDs, electric power generated by two power plants could be saved each year and the indirectly reduction in fuel consumption could be total one billion liters. Furthermore, carbon dioxide created during electrical power generation is also reduced, thereby reducing the greenhouse effect. Therefore, countries in Europe, America, and Japan have devoted a lot of manpower to white LED development. It is predicted that white LEDs can fully replace conventional illuminating apparatuses within ten years.

Although LEDs represent the future of illumination applications, many problems still remain unsolved. For example, with a high-power LED for illumination, only about 15-20% of input power is converted into light, and the remaining 80-85% is converted into heat. If heat is not dissipated to the environment efficiently, the temperature of the LED die will be too high, thus influencing the light emitting intensity and service life of the LED die. Therefore, heat management of LED devices is becoming a crucial issue.

As shown in FIG. 1, a traditional MR-16 high-power LED lamp 10 comprises a cuplike lamp housing 11, a lamp base 12, two plugs 13, an LED device 14, wires 15 and an insulation plate 16, a lens 17 and a lens cover 18. The LED device 14 is disposed on the insulation plate 16 and connected to the lamp base 12 through the wires 15, and the LED device 14 emits lights while the plugs 13 are connected to a power source. Generally, the inner surface of the cuplike lamp housing 11 is not reflective, so that the lens 17 is needed for effectively emitting the lights of the LED device 14. The lens cover 18 is configured to secure the lens 17. Moreover, the lens 17 would be replaced with a reflective surface to improve the LED light emission.

However, the above traditional LED lamp needs further lens or reflective surface to effectively emit LED lights, resulting in an increase in cost. In addition, the LED device is disposed on an insulation plate; therefore the heat cannot be effectively dissipated. Consequently, the LED lamp would soon be degraded.

According to the design, a traditional LED lamp is difficult to design with both a small size and a high efficiency of heat dissipation, and the LED device cannot disposed at the vicinity of the focal point (bottom) of the lamp housing. Instead, the LED device is disposed at a position exceeding 50% of total depth of the lamp housing, i.e., H_{L}/H_{T}>0.5, where H_{T} is the total depth of the cuplike lamp housing, and H_{L} is the distance between a surface of the LED device and the bottom of the cuplike lamp housing. Because the LED device tends to be placed too high, the LED device without an adjustment lens would scatter and cannot be used. But the LED device with a lens would increase the cost and be harmful to the performance of heat dissipation. Moreover, if the LED device is damaged, the entire LED lamp has to be replaced, so it is not cost-effective.

### SUMMARY OF THE INVENTION

The present invention is directed to providing an LED lamp and the LED device thereof. The LED lamp has a simple structure without a lens or a lamp cover, and has superior heat dissipation efficiency. Consequently, the LED lifetime can be increased, and the cost can be reduced. Moreover, the LED device of the present invention can be removed from the LED lamp, so that only the LED device needs to be replaced if it is damaged, thus the maintenance cost can be reduced.

The high-power LED lamp comprises a cuplike lamp housing, an LED device, an adapter and a circuit board. The inner surface of the cuplike lamp housing is a reflective curved surface configured to reflect the lights from the LED device disposed at the bottom of the cuplike lamp housing, so as to improve the lighting efficiency of the LED device. The adapter is configured to secure the LED device, and the circuit board is configured to provide power to the LED device. If H_{T} is the total depth of the cuplike lamp housing, and H_{L} is the distance between a surface of the LED device and the bottom of the cuplike lamp housing, the disposition of the LED device has the relation: 0.05<H_{L}/H_{T}<0.35.

Preferably, the inner surface of the adapter has female threads and the side surface of the LED device has corresponding male threads, by which the LED device can be secured with the adapter. The circuit board comprises a conductive point connected to the bottom of the LED device serving as a positive electrode, whereas the male threads on the side surface of the LED device serve as a negative electrode. A damaged LED device can be easily replaced via the configuration of male and female threads, so it is not necessary to replace the entire LED lamp.

The LED device is a stacked structure including an LED package device, a ring member and an electrode plate. The LED package device comprises LED dies and a metal base connected to the first electrode of the LED die. The ring member is disposed below the LED package device and having male threads on a side surface. The electrode plate is disposed below the ring member and is provided with a rod at the center thereof. The rod penetrates through the ring member and the center hole of the metal base of the LED package device. The top of the rod is connected to the second electrode of LED die. The electrode plate and the ring member serve as the positive electrode and the negative electrode, respectively, of the LED device.

In addition to the simplicity of the high-power LED lamp, the adapter and cuplike lamp housing are capable of dissipating heat. Moreover, the lens or lamp cover is not needed, so that the efficiency of heat dissipation can be further improved, thereby resolving the heat dissipation issue of the high-power LED.

### BRIEF DESCRIPTION OF THE DRAWINGS

FIG. 1 is an exploded view of a known high-power LED lamp;

FIGS. 2, 3(a) and 3(b) illustrate a high-power LED lamp in accordance with a first embodiment of the present invention;

FIGS. 4 and 5 illustrate a high-power LED lamp in accordance with a second embodiment of the present invention; and

FIG. 6 is an exploded view of an LED device according to the present invention.

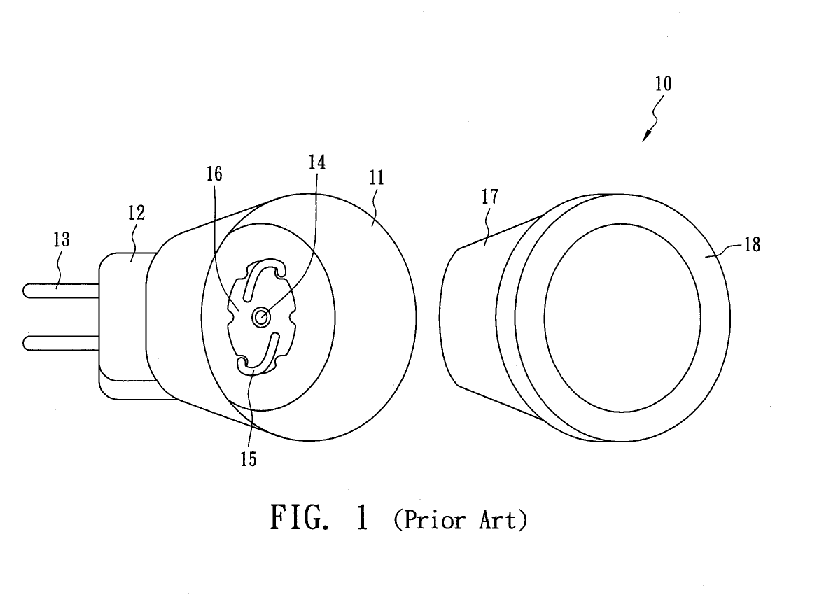

### DETAILED DESCRIPTION OF THE INVENTION

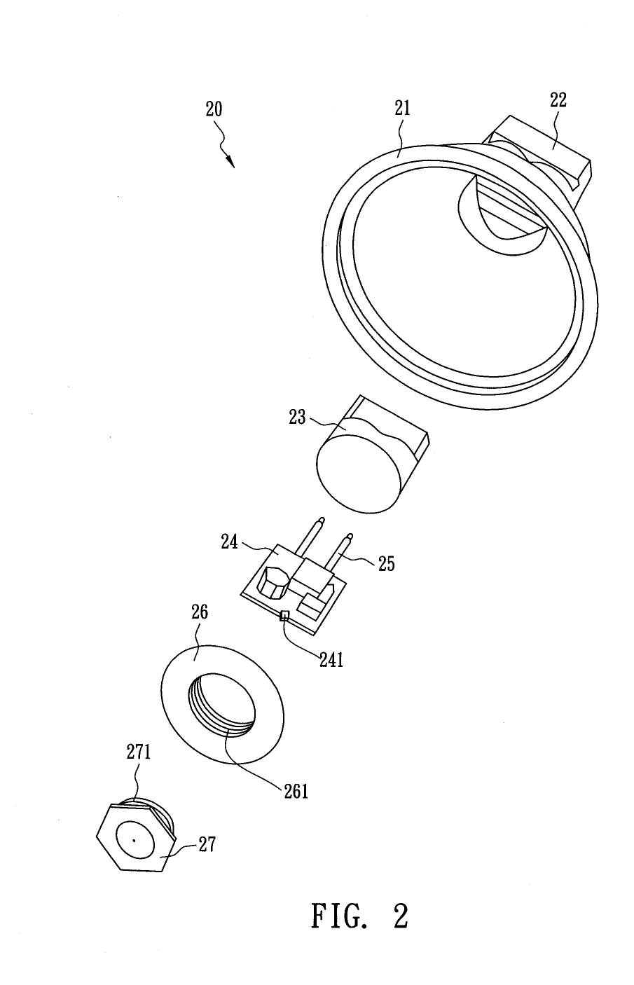

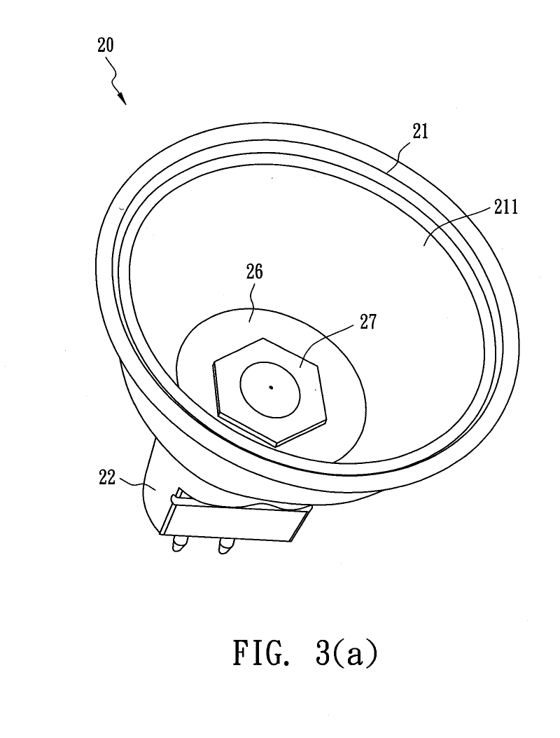

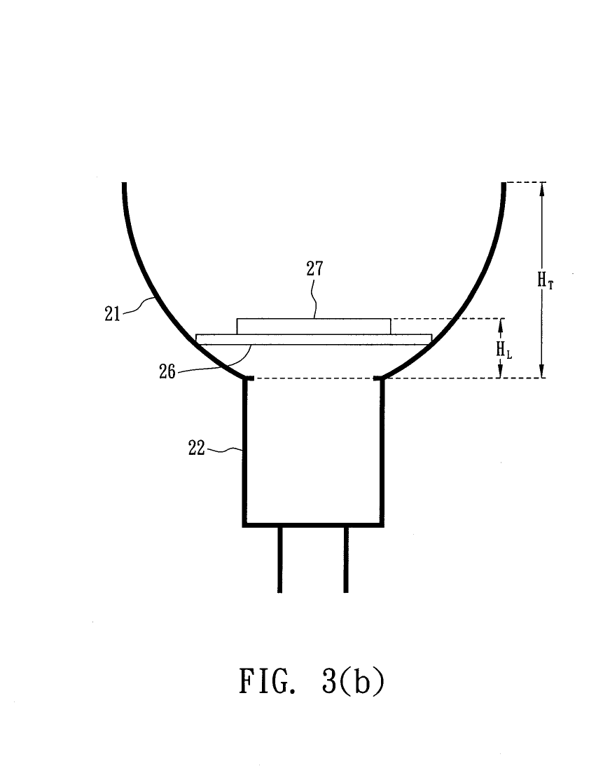

FIGS. 2, 3(a) and 3(b) illustrate a high-power LED lamp in accordance with a first embodiment of the present invention, in which FIG. 2 is an exploded diagram, FIG. 3(a) illustrates the high-power LED lamp after assembly, and FIG. 3(b) is the side view of the high-power LED lamp.

Referring to FIG. 2, a high-power LED lamp 20 comprises a cuplike lamp housing 21, a lamp base 22, a heat-dissipation glue member 23, a circuit board 24, an adapter 26, and an LED device 27.

An LED device normally can withstand 3.4 V and 350 mA, so that the LED device needs the circuit board 24 for voltage transformation because a traditional lamp of halogens (MR-16) uses 12V or 110V. The circuit board 24 has two plugs 25 to be in connection with a power source, and a conductive point 241 serving as connection point to the positive electrode of the LED device 27. The circuit board 24 associated with the heat-dissipation glue member 23 complies with the inner contour of the lamp base 22 and is disposed inside the lamp base 22. The inner surface of the adapter 26 is provided with female threads 261, which correspond to the male threads 271 of the LED device 27 for securing the LED device 27. Because the female threads are in direct contact with the LED device 27, heat dissipation of the LED device 27 can be further improved especially if the adapter 26 is made of metal.

Referring to FIG. 3(a), the inner surface of cuplike lamp housing 21 is a reflective curved surface 211 so as to effectively reflect the lights of the LED device 27. After the high-power LED lamp 20 is assembled, the LED device 27 is close to the bottom of the cuplike lamp housing 21, i.e., the focal point of the reflective curved surface 211, thus the light emission is more effective. FIG. 3(b) is a side view of the LED lamp 20 in FIG. 3(a), H_{T} is the total depth of the cuplike lamp housing 21; H_{L} is the distance between a surface of the LED device 27 and the bottom of the cuplike lamp housing 21. The ratio of H_{L}/H_{T} is 0.01<H_{L}/H_{T}<0.50, preferably 0.03<H_{L}/H_{T}<0.40, or most preferably 0.05<H_{L}/H_{T}<0.35.

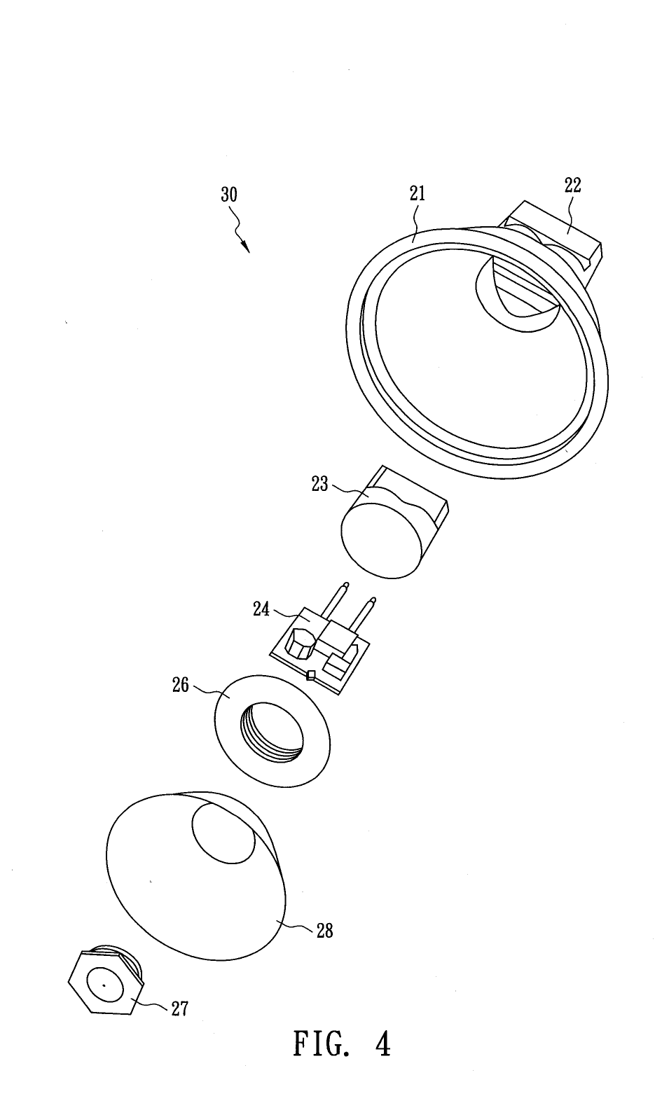

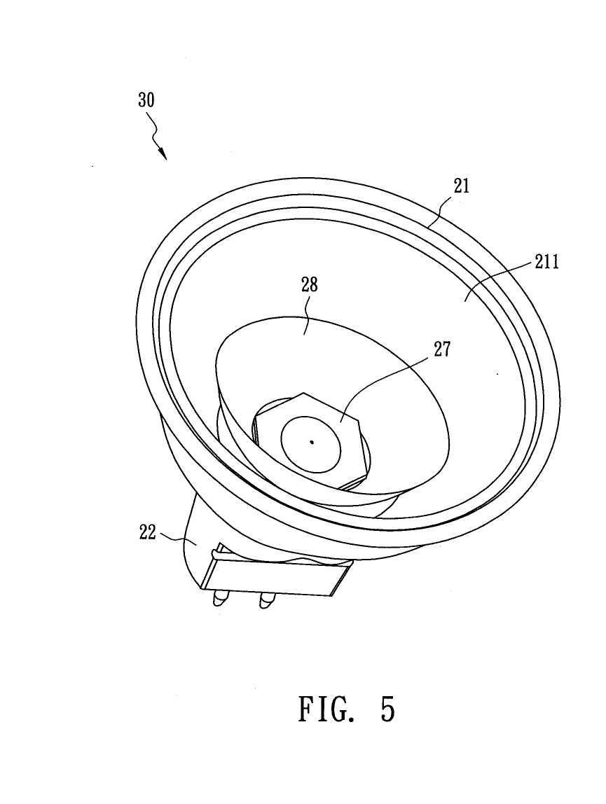

FIGS. 4 and 5 illustrate a high-power LED lamp in accordance with a second embodiment of the present invention. FIG. 4 is an exploded diagram, whereas FIG. 5 is the LED lamp after assembly. In comparison with the high-power LED lamp 20, the high-power LED lamp 30 of the second embodiment further introduces a heat dissipation cover 28 between the LED device 27 and the adapter 26 to improve heat-dissipation efficiency.

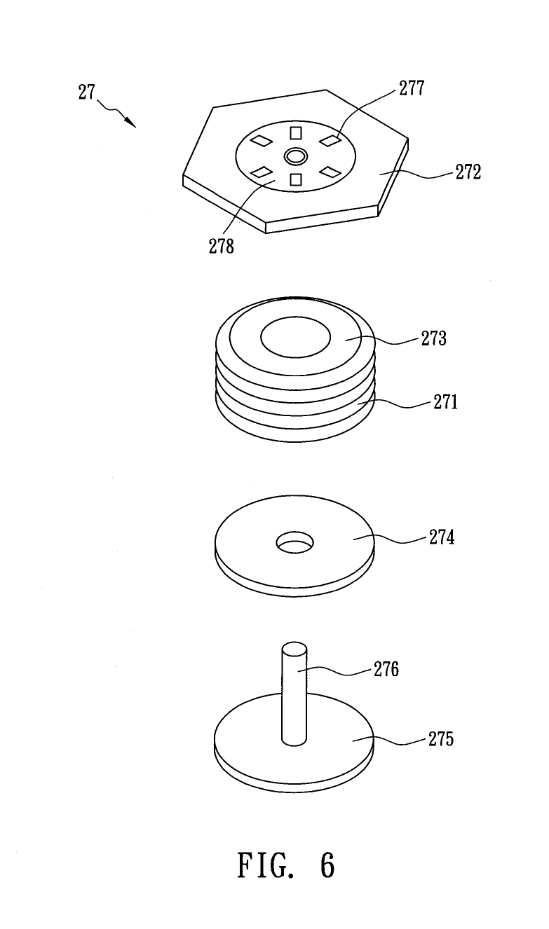

FIG. 6 is an exploded diagram of the LED device 27, comprising an LED package device 272, a ring member 273, an insulation glue layer 274 and an electrode 275, which are stacked. The LED package device 272 carries a package of the LED dies 277 on a metal base 278. A central hole is formed on the metal base 278 of the LED package device 272 to allow the rod 276 to penetrate through. The LED package device 272 is glued to the ring member 273 using spotting tin-paste, silver glue or heat conductive glue plate followed by solder reflow or high-temperature curing. The center of the electrode plate 275 is provided with a rod 276. The rod 276 penetrates through the central holes of the insulation layer 274, the ring member 273, and the LED package device 272. The cylindrical wall surface of the rod 276 is electrically insulated from the inner hole surface of the ring member 273. The electrode plate 275 and the rod 276 serve as a positive electrode of the LED device 27. The male threads 271 of the ring member 273, which are configured to connect to the adapter 26, serve as a negative electrode of the LED device 27. The insulation glue layer 274 is stacked between the electrode plate 275 and the ring member 273 for insulation between positive and negative electrodes. The insulation glue layer 274 has a heat conductive coefficient larger than 1.0 W/m-K.

The lens or lamp cover is not needed for the high-power LED lamp 20 or 30, and consequently the LED device 27 is exposed to air. Also, the adapter 26, the cuplike lamp housing 21 and heat-dissipation glue member 23 are all capable of heat dissipation. Therefore, the heat generated by the LED device 27 can be dissipated effectively, and thus the lifetime of the LED device 27 increases. Moreover, the LED device 27 can be replaced directly if damaged. It is not necessary to replace the entire LED lamp 20 or 30, so that maintenance costs can be significantly reduced.

The above-described embodiments of the present invention are intended to be illustrative only. Numerous alternative embodiments may be devised by those skilled in the art without departing from the scope of the following claims.

What is claimed is:

1. A high-power light emitting diode (LED) lamp, comprising:
a cuplike lamp housing having an inner surface with a reflective curved surface;
an LED device disposed at a bottom of the cuplike lamp housing, wherein lights of the LED device are reflected by the reflective curved surface, and the position of the LED device has a relation: 0.05<H_{L}/H_{T}<0.35, where H_{T} is the depth of the cuplike lamp housing, and H_{L} is a distance between a surface of the LED device and the bottom of the cuplike lamp housing;
an adapter configured to secure the LED device; and
a circuit board serving as an interface to provide power to the LED device.

2. The high-power LED lamp in accordance with claim 1, wherein a side surface of the LED device has male threads, and the adapter has female threads corresponding to the male threads for securing the LED device.

3. The high-power LED lamp in accordance with claim 1, wherein the circuit board comprises a conductive point connected to a bottom of the LED device serving as a positive electrode.

4. The high-power LED lamp in accordance with claim 1, further comprising a lamp base disposed at the bottom of the cuplike lamp housing, wherein the circuit board is associated with a heat conductive glue member and disposed inside the lamp base.

5. The high-power LED lamp in accordance with claim 1, further comprising a heat dissipation cover disposed between the LED device and the adapter.

6. The high-power LED lamp in accordance with claim 2, wherein the LED device comprises:
an LED package device comprising at least one LED die and a metal base connected to a first electrode of the LED die;
a ring member disposed below the LED package device, and having male threads on a side surface thereof;
an electrode plate disposed below the ring member and comprising a rod penetrating through the ring member, a top of the rod being connected to a second electrode of LED die; and
an insulation glue layer stacked between the electrode plate and the ring member for insulation.

7. The high-power LED lamp in accordance with claim 6, wherein the electrode plate serves as a positive electrode of the LED device.

8. The high-power LED lamp in accordance with claim 6, wherein the male threads serve as a negative electrode of the LED device.

9. The high-power LED lamp in accordance with claim 6, wherein the insulation glue layer has a heat conductive coefficient larger than 1.0 W/m-K.

10. A high-power LED device configured to be assembled in an LED lamp, the LED lamp comprising an adapter having female threads inside, the high-power LED device comprising:
an LED package device comprising at least one LED die;
a ring member disposed below the LED package device and having male threads corresponding to the female threads on a side surface thereof;
an electrode plate disposed below the ring member and comprising a rod penetrating through the ring member, a top of the rod being connected to a bottom of the LED package device; and
an insulation glue layer stacked between the electrode plate and the ring member for insulation.

11. The high-power LED device in accordance with claim 10, wherein the ring member and the adapter are electrically connected as a negative electrode of the high-power LED device.

12. The high-power LED device in accordance with claim 10, wherein the electrode plate serves as a positive electrode of the high-power LED device, and the male threads of the ring member serve as a negative electrode of the high-power LED device.
